(19) United States
(12) Patent Application Publication
(10) Pub. No.: US 2005/0050333 A1
(43) Pub. Date: Mar. 3, 2005

(54) System and method for secure broadcast

(75) Inventors: Tet Hin Yeap, Ottawa (CA); Dafu Lou, Ottawa (CA); William G. O'Brien, Orleans (CA)

Correspondence Address: TORYS LLP, 79 WELLINGTON ST. WEST, SUITE 3000, TORONTO, ON, M5K 1N2, CA

(73) Assignee: BCE Inc., Montreal (CA)

(21) Appl. No.: 10/926,944

(22) Filed: Aug. 27, 2004

Related U.S. Application Data
(60) Provisional application No. 60/497,909, filed on Aug. 27, 2003.

(51) Int. Cl. G06F 11/30

(52) U.S. Cl. 713/182; 713/201

(57) ABSTRACT

A novel system and method for secure communication is provided. In an embodiment, a satellite pay-tv system is provided that includes a head end office that broadcasts programming to one or more subscriber stations via satellite. The subscriber station includes a set top box operable to receive a smart card. The subscriber station is configured to only receive programming if the smart card contains a serial number that corresponds with the serial number of the subscriber station. Methods are provided for updating the smart card profile.

### PRIORITY CLAIM

The present non-provisional patent application claims priority from U.S. Provisional Patent Application No. 60/497,909, the contents of which are incorporated herein by reference.

### FIELD OF THE INVENTION

The present invention relates generally to telecommunications and more particularly to a system and method for secure broadcast.

### BACKGROUND OF THE INVENTION

Media broadcasting is a well known form of communication. Radio, television and internet are well known examples of media that are used to carry broadcasts. Traditional broadcasting, such as found in traditional radio and television broadcasts, are typically insecure, in that any receiver within range of the broadcast is able to receive and present the broadcast to an audience.

More recently, with the advent of digital communications, it is becoming common to conduct broadcasts in a secure manner, as a means of obtaining payment for enjoyment or other use of the broadcast by the audience. Examples of secure broadcasts include Pay-TV broadcasts carried over satellite or coaxial cable. In satellite television (“TV”) broadcasts, the program content is encrypted prior to broadcast The audience (hereafter referred to as “subscribers” or “subscriber”) will pay a subscription to receive the broadcast. Once the appropriate fees are paid, the subscriber will receive a technological device for decrypting the broadcast. As will be explained in greater detail below, however, current technology for encrypting and decrypting the broadcast has limitations, subjecting the broadcast to theft.

The general problem can be described as how to securely broadcast information over an insecure broadcast channel, such as via satellite in the Pay-TV satellite broadcast service operated by the assignee of the present application.

In a typical Pay-TV satellite broadcast service, the head-end office (“HEO”) multicasts an encrypted TV program to a set of subscribers who have subscribed to the service using the satellite broadcast channel. Each subscriber has a Set-Top Box (STB) which receives the encrypted broadcast TV program and decrypts the encrypted information, provided that the subscriber is entitled to the TV program.

Currently, a secure satellite transmission is typically performed using Public Key Encryption. Two keys are used in a public key encryption system: public and private keys. The public key is public and everyone can access it, while the private key is kept secret inside the STB. Usually there is no need for the service provider to transmit the public key with the signals. However, in most Pay-TV satellite broadcast systems, multiple public keys are transmitted along with the signal that has been encrypted by one of these public keys using conventional symmetric encryption technique such as RC-4.

To actually receive a Pay-TV satellite broadcast, a subscriber typically obtains a smart card from the service provider that contains a Pay-TV subscription code. The subscriber inserts the smart card into the receptacle in a STB. The subscription code in the smart card is then combined with the expected ID number of the STB to generate the private key. The private key is then used only to authenticate the subscription. After the subscriber has been authenticated, the corresponding public key is used to decrypt the Pay-TV signal. Note that a simpler symmetric cryptography technique such as RC-4 is used in the encryption/decryption of the satellite signal because it is less computational intensive compared with the public key cryptography.

One problem with current Pay-TV satellite broadcast systems is that it is very easy to steal the satellite signal. The following is an example procedure of stealing a Pay-TV satellite signal. First, the Joint Test Action Group (“JTAG”) facility of the receiver is used to read the ID number of receiver; Second, the ID number of the receiver and the smart card number for basic program subscription from the service provider are entered into a smart-card emulator; Third, the smart card emulator is plugged into the smart card receptacle of the STB and the emulator then generates the appropriate number for the STB to generate a private key for the encrypted broadcast

Various ways have been proposed to improve security in broadcasts, including U.S. patent Publication No. 2003061477 entitled “Method and apparatus for encrypting media programs for later purchase and viewing” and filed Sep. 21, 2003. U.S. 2003061477 discloses a method and apparatus for storing and retrieving program material for subsequent replay. The method includes accepting a receiver ID associated with a receiver key stored in a memory of the receiver, determining a pairing key for encrypting communications between a conditional access module (such as a smartcard) and the receiver, encrypting the pairing key with the receiver key, and transmitting a message comprising the encrypted pairing key to the receiver. The apparatus comprises a receiver for receiving a data stream carrying a media program encrypted according to a media encryption key and an encrypted media encryption key and the conditional access module. Regardless of any security advantages that U.S. 2003061477 may offer, the method and apparatus therein utilizes a powerful and specialized smartcard to process part of the video signal. Such a powerful and specialized smartcard would thus increase the cost and complexity of the hardware.

U.S. Pat. No. 5,029,207 entitled “External security module for a television signal decoder” and issued Feb. 7, 1991 discloses a decoder for descrambling encrypted or encoded satellite transmissions that include an internal security element and a replaceable security module, such as a smartcard. The program signal is scrambled with a key and then the key itself is twice-encrypted and multiplexed with the scrambled program signal. The key is first encrypted with a first secret serial number (SSN1) which is assigned to the smart card. The key is then encrypted with a second secret serial number (SSN0) which is assigned to a given decoder. The decoder performs a first key decryption using the second secret serial number (SSN0) stored within the decoder. The partially decrypted key is then further decrypted by the smart card using the first secret serial number (SSN1) stored within the smart card. The decoder then descrambles the program using the twice-decrypted key. The smart card can be replaced, allowing the security system to be upgraded or changed following a system breach. U.S. Pat. No. 5,029,207 ultimately uses the symmetric encryption technique commonly found in the Data Encryption Standard (“DES”). While double encryption is used, the security in the apparatus is still relatively easy to break, as those of skill in the art will appreciate the DES has been shown to have serious weaknesses.

Yet another solution is proposed in U.S. Pat. No. 6,466,671 entitled “Smartcard for use with a receiver of encrypted broadcast signals, and receiver” and issued Oct. 15, 2002. U.S. Pat. No. 6,466,671 discloses a smartcard for use with a receiver of encrypted broadcast signals that comprises a microprocessor for enabling or controlling decryption of said signals. A memory is coupled to the microprocessor. The microprocessor is adapted to enable the individual decryption of a plurality of such signals from respective broadcast suppliers of such signals by means of respective dynamically created zones in the memory, the dynamically created zones each being arranged to store decryption data associated with a respective one of said broadcast suppliers. However, somewhat similar to U.S. 2003061477, U.S. Pat. No. 6,466,671 uses a very powerful and specialized smartcard to decrypt the video signal, which increases the cost and/or complexity of the hardware. In addition, the disclosed solution in U.S. Pat. No. 6,466,671 can result in a heat dissipation problem in the smart card, when a high speed processor associated therewith is used to decrypt an encyprted video signal.

A further solution is proposed in U.S. patent Publication No. US2002018568 entitled “Method and system for encrypting and storing content to a user”, filed Aug. 3, 2001 and published Feb. 14, 2002. US2002018568 discloses various systems and methods for encrypting content sent to a user. In US2002018568, the user terminal, or receiver, is assigned a serial number. When content is received by the receiver, it is encrypted and the serial number is embedded into the encrypted content. The content is decrypted if the serial number embedded in the encrypted content is the serial number associated with the receiver. One problem with US2002018568 is that it uses a symmetric encryption/decryption approach to decrypt, which again is an approach known to have weaknesses. In addition, however, the serial number of the STB in this approach is known to the public.

In general, existing methods of broadcast information securely from a HEO to a set of subscribers over an insecure broadcast channel via satellite or other media are lacking in certain respects.

### SUMMARY OF THE INVENTION

It is an object of the present invention to provide a novel system and method for secure broadcast that obviates or mitigates at least one of the above-identified disadvantages of the prior art.

In a broad aspect of the invention, the Head-End Office broadcasts an encrypted Pay-TV program to a set of subscribers via a satellite. Each subscriber has a STB which receives and decrypts the encrypted Pay-TV program, if the subscriber is entitled to the TV program. A smart card containing encrypted subscription information and serial number of the STB is plugged into a receptacle of the STB. To reduce the likelihood of the content of a smart card being copied for mass distribution by unauthorized persons, public key cryptography is used in the STB so that the STB will only read the subscription information from a smart card with the same serial number as the STB during a boot-up process. Otherwise, the STB will not boot-up.

In addition, public key cryptography with a dynamic key is also applied to the encryption/decryption of Pay-TV signal, so that it will be difficult for an unauthorized person to steal the Pay-TV program. To reduce the amount computations required in encryption and decryption of satellite, multiplication of keys and video data instead of full public key cryptography encryption/decryption technique can be used.

The secure update of user profile and private key in the Set-Top Box and the smart card via a PSTN channel using public key cryptography can also be used. The authentication can be used in the update to avoid unauthorized access to the STB and HEO.

An aspect of the invention provides a removable security device for communication with one or more subscriber stations that each have a unique identifier. The device comprises a medium for storing a user profile, the user profile includes a second identifier for instructing the subscriber station to receive programming if the second identifier corresponds to the unique identifier. The unique identifier can be a serial number of a set top box respective to the subscriber station and the second identifier can be a second serial number and the correspondence occurs when the serial numbers match. The security device can have a form factor selected from the group consisting of a smart card, a radio-frequency tag, and a magnetic stripe card. The medium is typically rewritable for updating the user profile.

The subscriber station can be a pay-TV subscriber station. The user profile can be stored in an encrypted format and the subscriber station will include a means for decrypting the user profile.

The user profile further can include an encryption key for decrypting programming received at the subscriber station.

The user profile can further include subscriber programming information for instructing the subscriber station to decrypt only selected portions of programming received at the subscriber station.

Another aspect of the invention provides a receiver operable to communicate with a removable security device for storing an indicium, the receiver being operable to present data received by the receiver only if the indicium matches a criterion unique to the receiver. The receiver can be a subscriber station in a pay-tv system and the data is a pay-tv broadcast. The removable security device can further include subscriber program information and the receiver will only present a portion of the broadcast corresponding to the subscriber programming information. The receiver can have a serial number and the criterion is met only if the indicium matches the serial number.

An aspect of the invention provides a system for broadcasting comprising a transmitter operable to broadcast over a channel and a receiver operable to receive the broadcast over the medium. The receiver is further operable to communicate with a removable security device that stores an indicium. The receiver only operates to present the received broadcast if the indicium meets a criterion local to the respective subscriber station.

The system can be party of a pay-tv system. In this case, the receiver is a subscriber station. The indicium is a serial number of the subscriber station and the criterion is met if the indicium matches the serial number. The transmitter is a head-end office and the broadcast is a Pay-TV service. The channel is can be a wireless channel carried by a satellite or channel carried on a CATV network.

The broadcast can be encrypted and in which case the broadcast can be presented by decrypting the broadcast. The decryption key for the broadcast is stored on the removable security device and the decryption key is usable by the receiver to present the broadcast only if the indicium meets the criteria.

A selected set of subscriber program information can be stored on the removable security device and the receiver can be operable to only present a portion of the broadcast that corresponds to the selected set.

Another aspect of the invention provides a method of receiving a broadcast comprising the steps of:
downloading a user profile from a removable security device that is in communication with a set-top box having a serial number;
presenting the broadcast only if the user profile includes an indicium that matches the serial number.

Another aspect of the invention provides a method of initializing a set top box having a unique serial number comprising the steps of:
initializing the set-top box;
downloading a user profile from a smart card in communication with the set-top box;
determining if the user profile contains an indicium that matches the serial number;
terminating the initialization if the indicium does not match the serial number; and,
completing the initialization if the indicium matches the serial number.

The method can comprise the additional steps of:
extracting a decryption key from the user profile for decrypting broadcasts received by the set-top box;
decrypting the broadcast using the decryption key; and,
presenting the decrypted broadcast.

The method can also comprise the additional steps of:
extracting subscriber program information from the user profile;
presenting only a portion of a received broadcast that corresponds with the subscriber program information.

Another aspect of the invention provides a method of updating a user profile stored on a smart card in communication with a set top box comprising the steps of:
transmitting, from the set top box, a request to update the user profile,
transmitting, from the set top box, the user profile to a head end office;
determining, at the head end office, whether the user profile contains an indicium that matches a serial number of the set top box;
terminating the method if the indicium does not match the serial number,
generating, at the head end office, an updated user profile based on the request;
transmitting, from the head end office, the updated user profile to the set top box; and,
storing the updated user profile on the smart card.

### BRIEF DESCRIPTION OF THE DRAWINGS

The invention will now be described by way of example only, and with reference to the accompanying drawings, in which:

FIG. 1 shows a system for secure broadcast in accordance with an embodiment of the invention;

FIG. 2 is a block diagram depicting various encryption keys and their storage locations in the system of FIG. 1;

FIG. 3 is a flow chart depicting a method of secure broadcast in accordance with another embodiment of the invention;

FIG. 4 is a flow chart depicting a set of sub-steps for one of the steps of the method in FIG. 3;

FIG. 5 is a flow chart depicting a method of updating a user profile in accordance with another embodiment of the invention;

FIG. 6 is a block diagram of an new user profile generated using the method in FIG. 5;

FIG. 7 is a block diagram depicting the transmission of the new user profile of FIG. 6 when using the method shown in FIG. 5;

FIG. 8 is a block diagram depicting the updating of the user profile in the set top box and smart card using the method shown in FIG. 5;

FIG. 9 is a schematic representation of an encryption technique for a broadcast; and,

FIG. 10 shows a system for secure broadcast in accordance with another embodiment of the invention.

### DETAILED DESCRIPTION OF THE INVENTION

In accordance with a first embodiment of the invention, a system for secure broadcast is indicated generally at 30. System 30 is comprised of a head-end office (“HEO”) 34 and at least one subscriber station 38 that are interconnected by a satellite 42 and the public switched telephone network (“PSTN”) 46.

HEO 34 comprises a satellite signal modulator 50 that modulates signals transceived by an HEO satellite dish 54 via a satellite communication channel 56. (As used herein, the term “transceive” refers to both transmission and reception of signals.) HEO 34 further comprises an encryption device 58 that interconnects a server 62 with modulator 50. HEO 34 also includes a server 62 that connects to encryption device 58 and at least one modem 66 for interfacing device 58 with PSTN 46.

Subscriber station 38 comprises a set top box (“STB”) 70 that demodulates signals received by a subscriber station satellite dish 74 via a satellite broadcast channel 78. Subscriber station 38 also includes a television 78 or other type of receiver capable of presenting programs or other content received from satellite dish 74. Subscriber station 38 also includes a smart card 82 (or other type of replaceable security module) that is removably receivable within a smart card reader located in STB 70. Thus, in the present embodiment, subscriber station 38 is operable to receive pay-TV service from satellite 42.

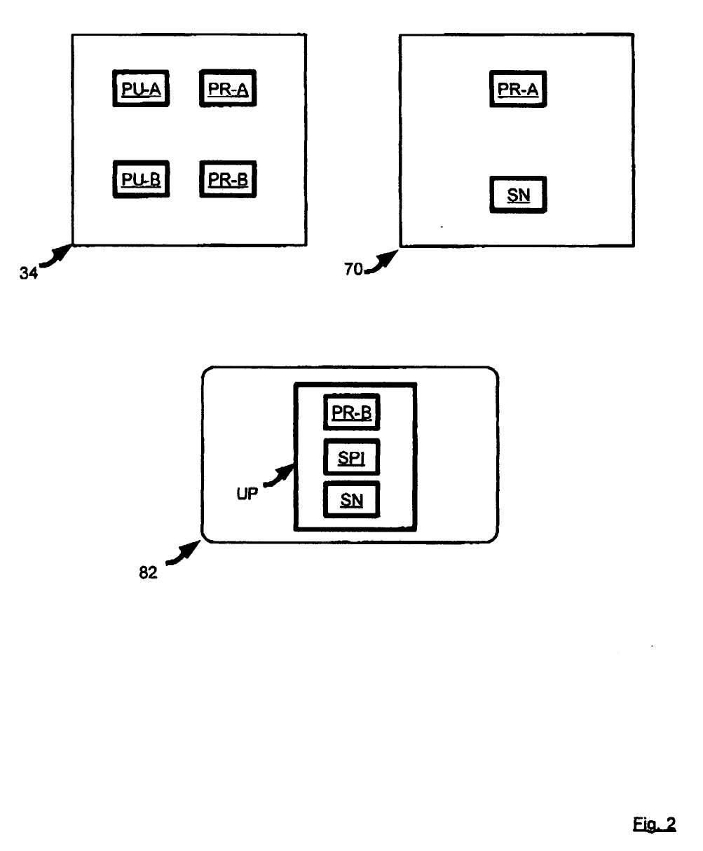

FIG. 2 shows the location of storage of certain software objects in system 30. In particular, HEO 34 stores a first public key PU-A and a first private key PR-A that asymmetrically complements public key PU-A. HEO 34 also stores a second public key PU-B and second private key PR-B that asymmetrically complements public key PU-B. Keys PU-A, PR-A, PU-B and PR-B can be based on the Elliptic Curve Digital Signature Algorithm (“ECDSA”) and/or the RSA algorithm and/or the like. Typically, whichever encryption scheme is used, it is presently preferred to use schemes with reduced computational overhead, while still providing a desired level of security, such as the ECDSA, or the hyper elliptic curve algorithm. It should be understood that the objects stored in HEO 34 can be physically stored in any appropriate storage device located on either of encryption device 58 or server 62. As will be explained further below, keys PU-A and PR-A are used for authenticating a particular smart card 82 used in association with a particular STB 70. Keys PU-B and PR-B (and key PU-B in particular) are used for the encryption of programming delivered over channels 56 and 76 via satellite 42

Referring still to FIG. 2, STB 70 also stores first private key PR-A, as well as a serial number SN that is unique to STB 70. Thus, it is to be understood that system 30 typically includes multiple subscriber stations 38, and that each STB 70 within system 30 may thus store identical copies of first private key PR-A, but would store a serial number SN that is completely unique to that particular STB 70. Also, while not required, it is presently preferred that first private key PR-A is stored in an encrypted manner in STB 70, to reduce the likelihood of the identity of first private key PR-A being ascertainable or copyable by anyone who has access to STB 70. To extract private key PR-A, on boot-up STB 70 executes a piece of boot-up firmware to decrypt the encrypted copy of private key PR-A, and stores private key PR-A in the random access memory of STB 70 for later use.

Still referring to FIG. 2, smart card 82 stores a unique user profile UP that itself contains copy of second private key PR-B, a subscriber program information SPI, and serial number SN. User profile UP is itself stored on smart card 82 using first public key PU-A, such that when smart card 82 is inserted into STB 70, first private key PR-A in STB 70 can be used to extract unique user profile UP from smart card 82. Once STB 70 has access to the unencrypted contents of user profile UP, STB 70 can then obtain second private key PR-B for use in decrypting programming received over channel 76, and can use subscriber program information SPI to verify exactly which programming that is received over channel 76 has actually been paid for by the subscriber at subscriber station 38. Thusly, STB 70 will present programming on television 78 in accordance with the programming that has been paid for as indicated in subscriber program information SPI. Additionally, however, STB 70 will only present such programming if serial number SN stored in user profile UP actually matches the serial number SN stored in STB 70.

To create user profile UP, the subscriber respective to subscriber station 38 chooses certain subscriber program information SPI from the choices made available by the service provider operating HEO 34 and then user profile UP would be generated, with particular attention paid to ensuring that the serial number SN of STB 70 belonging to that subscriber was saved as part of the user profile UP stored on smart card 82. By further encrypting the contents of user profile UP, additional copy protection for the card is provided, and accordingly private key B is protected. However, by further including serial number SN in user profile 82, even accessing private key B off of smart card 82 will be insufficient to pirate programming on channel 76, as STB 70 is configured to ignore any smart card 82 that does not contain a copy of the serial number SN respective to that STB 70.

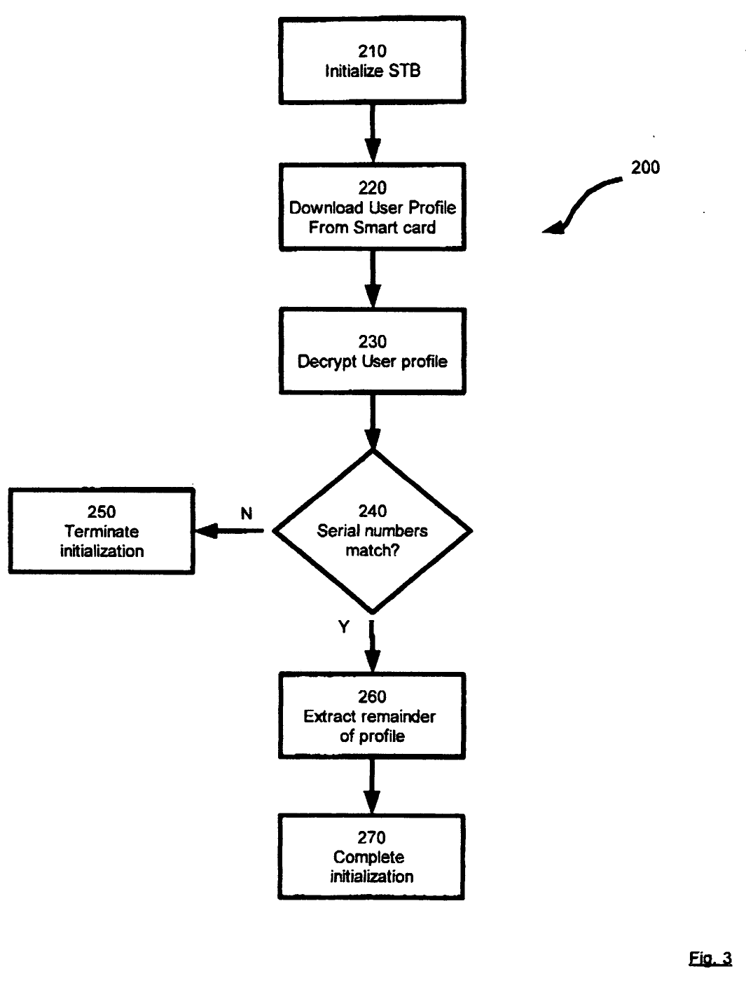

Referring now to FIG. 3, a method for secure broadcast is indicated generally at 200. In order to assist in the explanation of the method, it will be assumed that method 200 is operated using system 30. Furthermore, the following discussion of method 200 will lead to further understanding of system 30. (However, it is to be understood that system 30 and/or method 200 can be varied, and need not work exactly as discussed herein in conjunction with each other, and that such variations arc within the scope of the present invention.) Of note, prior to execution of method 200, it is assumed that smart card 82 is inserted into STB 70.

Beginning first at step 21 0, the STB is initialized. When implemented on system 30, STB 70 will either be “powered-on” from a powered-off state, or “reset” using either soft or hard reset functionality inherent to STB 70. At step 220, the user profile is downloaded from the smart card.

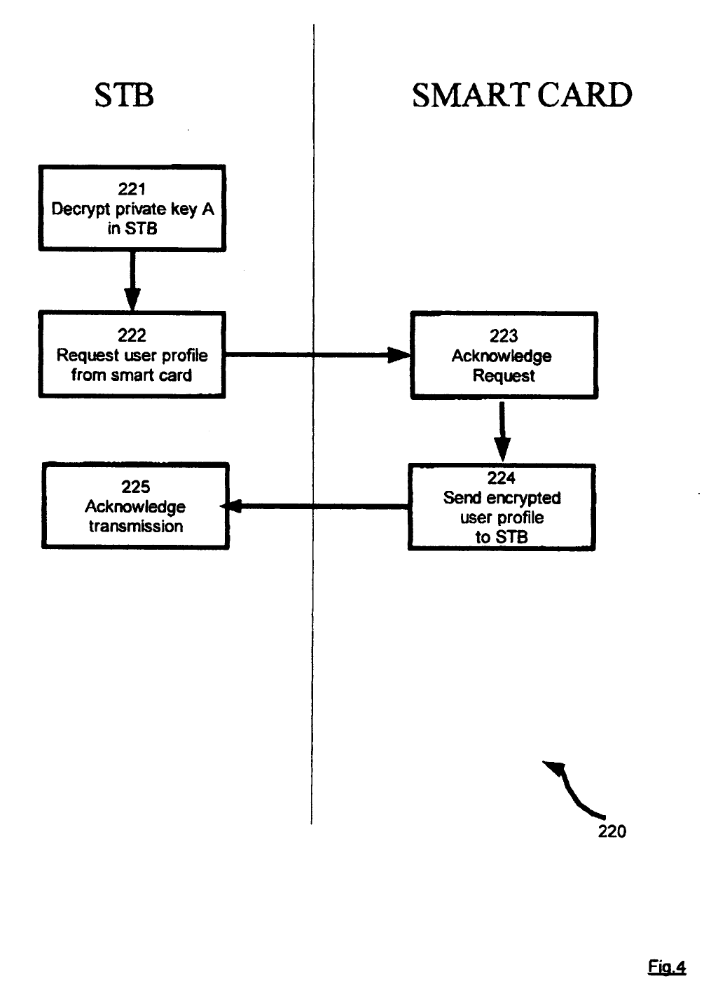

When implemented on system 30, step 220 is performed using the sub-steps shown in FIG. 4. At sub-step 221, the encrypted copy of private key PR-A that is permanently stored in STB 70 is decrypted using a respective portion of boot-up firmware. The decrypted copy of private key PR-A is then transferred to random access memory in STB 70 for subsequent use. At step 222, STB 70 sends a request to smart card 82 to obtain user profile UP from smart card 82. At step 223, smart card 82 acknowledges the request. At step 224, the encrypted user profile UP stored in smart card 82 is sent to STB 70. Next, at step 225, STB 70 sends an acknowledgement of receipt of the encrypted user profile UP back to smart card 82.

Referring again to method 200 in FIG. 3, at step 230, the encrypted copy of user profile UP that was received from smart card 82 is decrypted using the copy of private key PR-A decrypted at step 221. At step 240, a determination is made as to whether the serial numbers match. In particular, STB 70 will examine its own serial number SN and compare it with the serial number that was stored in user profile UP. If those two serial numbers do not match, then the method advances to step 250 and the initialization is terminated, and STB 70 will not operate to decrypt channel 76. However, if the two serial numbers do match, then the method advances to step 260, and the remainder of the user profile is extracted. In particular, private key PR-B and subscriber program information SPI are extracted from user profile UP. At step 270, the remainder of the initialization of STB 70 is completed. At this point, STB 70 will now operate to decrypt channel 76 using private key PR-B to present the portions of channel 76 on television 78 that include programming that correspond to the programming authorized in subscriber program information SPI.

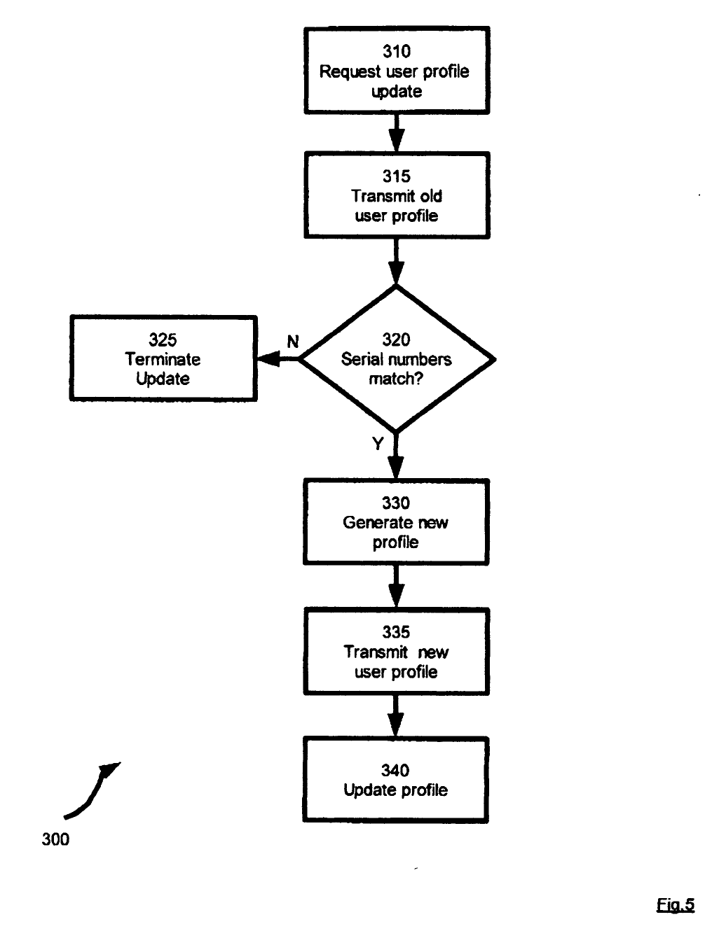

Referring now to FIG. 5, a method for updating a user profile is indicated generally at 300. In order to assist in the explanation of the method, it will be assumed that method 300 is operated using system 30. Furthermore, the following discussion of method 300 will lead to further understanding of system 30. (However, it is to be understood that system 30 and/or method 300 can be varied, and need not work exactly as discussed herein in conjunction with each other, and that such variations are within the scope of the present invention.) Of note, prior to execution of method 300, it is assumed that smart card 82 is inserted into STB 70.

Beginning at step 310, a request for a user profile update is made. When implemented on system 30, an instruction is given to STB 70 via a remote control device or other input device attached thereto that an update to user profile UP is desired. STB 70 then initiates a communication to server 62 via PSTN 46 that such an update has been requested, and waits for an acknowledgement (also sent via PSTN 46) that the request for upgrade has been received by HEO 34. Once the acknowledgement is received, the method advances to step 315, but if no acknowledgement is received then step 3 1 0 repeated until acknowledged is received.

At step 315, the old user profile is transmitted. When implemented on system 30, an STB 70 downloads user profile UP from smart card 82, and transmits user profile UP to HEO 34 via PSTN 46. Typically, user profile UP is sent over PSTN 46 in its encrypted form as it is saved on smart card 46. When HEO 34 receives the encrypted form of user profile UP, it is decrypted using private key PR-A.

Next, at step 320, it is determined whether the serial numbers stored in the user profile and the set top box match. Continuing with the example using system 30, at this point server 62 compares the serial number SN decrypted from user profile UP, and compares that serial number SN with its record of the serial number SN respective to STB 70. Put in other words, server 62 maintains a database of all serial numbers of all STBs within the system, and, at step 320, will use that database to determine whether the serial number SN of the received user profile UP matches with an expected serial number SN of the STB 70 from which the user profile was received.

If, at step 320, it is determined that there is no match between the serial numbers, then the method advances to step 325 and the update is terminated, owing to the a detected breach in security.

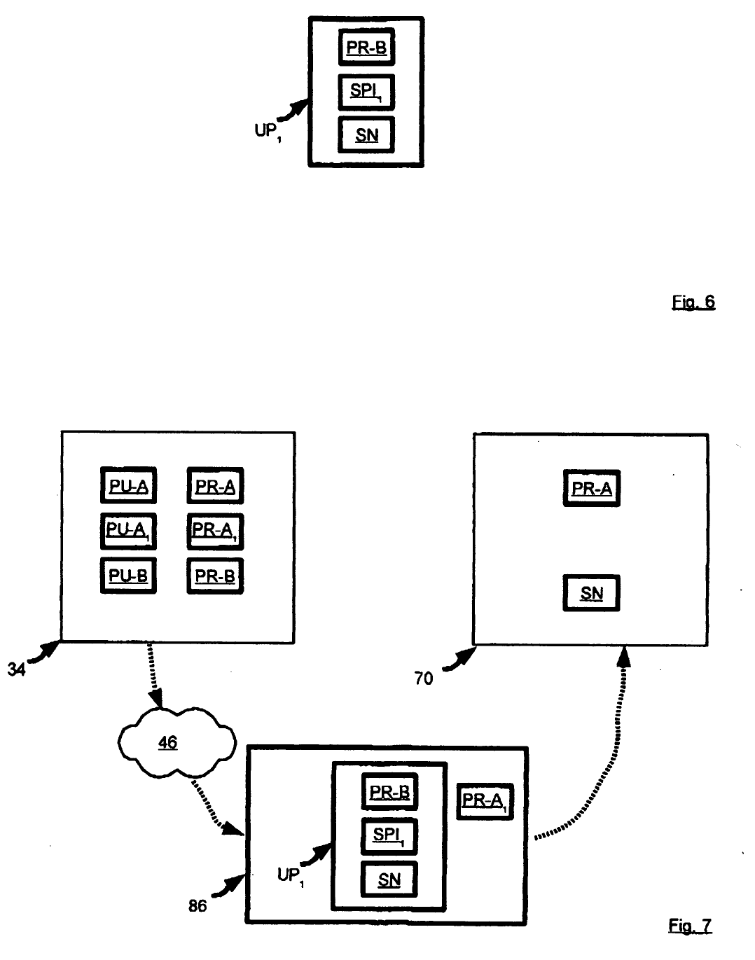

If, however, at step 320 it is determined that there is a match between the serial numbers, then the method advances to step 330. At step 330, a new user profile is generated to reflect the desired update. FIG. 6 shows a new user profile UP₁ that is an example of the result of the generation at step 330. New user profile UP₁ includes a new subscriber program information SPI₁, which reflects the substantive portion of the update. Thus, new subscriber program information SPI₁ is typically different from subscriber program information SPI, and reflects new programming choices for the subscriber that owns subscriber station 38. New user profile user profile UP₁ also includes private key PR-B and the serial number SN of STB 70.

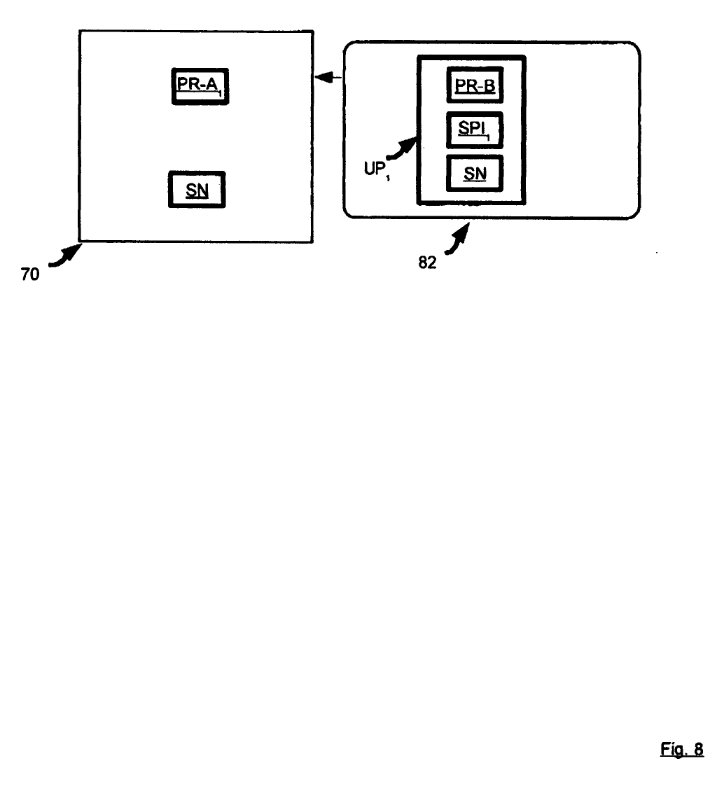

At step 335, new user profile UP₁ is transmitted. An example of the performance of this step is shown in FIG. 7, where an update package 86 is shown being transmitted from HEO 34 to STB 70 via PSTN 46. In a present embodiment, update package 86 includes new user profile UP₁ and a new private key PR-A₁ that corresponds to a new public key PU-A₁, which are generated by and stored at HEO 34. New user profile UP₁ is itself encrypted by server 62 within update package 86 using new public key PU-A₁. The entire update package 86 is encrypted using public key PU-A before transmission over PSTN 46. Thus, once update package 86 is received at STB 70, it is decrypted using private key PR-A stored in STB 70.

At step 340, the user profile is actually updated. An example of the performance of this step is shown in FIG. 8, wherein user profile UP₁ is shown as having been saved on smart card 82 by STB 70. Of particular note, having decrypted new user profile UP₁, STB 70 will take new private key PR-A₁ and store it in STB 70 for later use, replacing private key PR-A, thereby providing additional security for system 30. Thus, user profile UP₁ is stored on smart card 82 in an encrypted format using new public key PU-A₁, and is available for extraction by STB 70 using new private key PR-A₁ during a boot-up or initialization of STB 70, such as described above with reference to method 200.

The method 300 can then terminate in any desired manner, such as by including a final handshake between HEO 34 and STB 70 via PSTN 46 that the update to the user profile was successful, and thereby allowing both HEO 34 and STB 70 to terminate their respective operation of method 300.

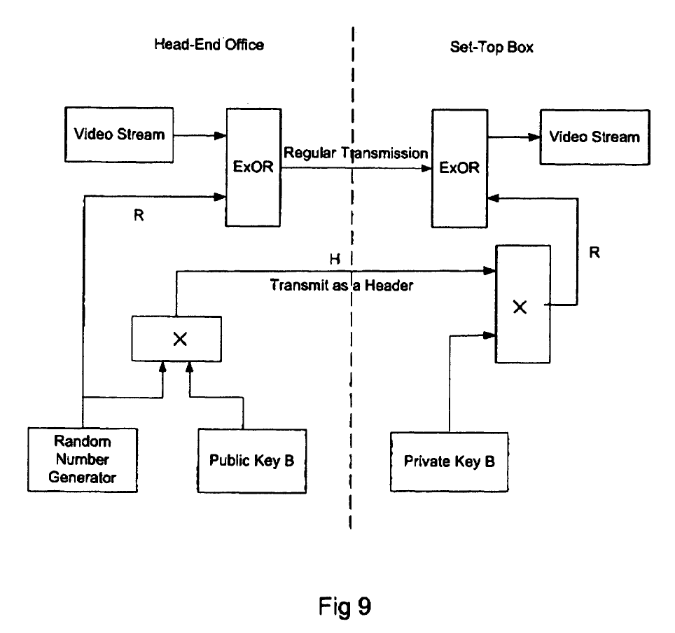

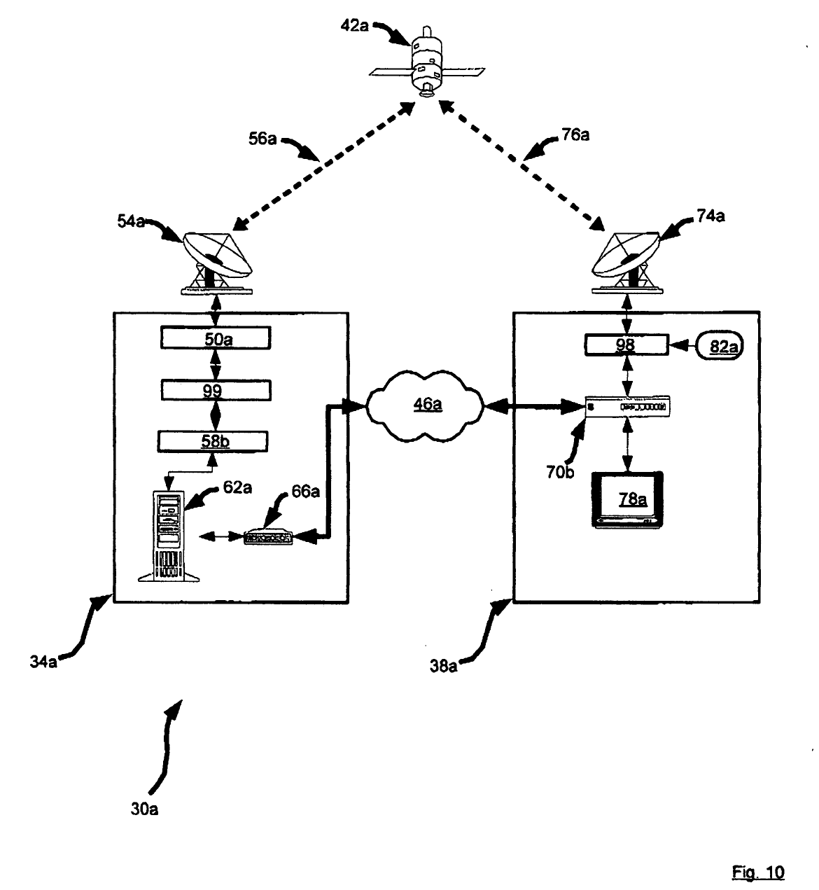

When system 30 is operating to broadcast programming to STB 70 via channel 76, HEO 34 will typically transmit programming over channel 56 in an encrypted format using public key PU-B. STB 70 can then use public key PR-B that is saved in smart card 82 (and retrieved by STB 70 during method 200) to decrypt the programming. For further security, as shown in FIG. 9, it is contemplated that HEO 34 could also generate a random number “R” to be EXORed (i.e. where EXOR means ‘exclusive or’) with the video signal to encrypt the actual broadcast. The random number will be multiplied with public key PU-B, and the product of this multiplication is a new encrypted random number to be transmitted as a header to the programming. STB 70 could multiply private key PR-B by the encrypted random number to retrieve the original random number “R” that is used to encrypt the video signal. STB 70 then EXORs the encrypted incoming video stream received over channel 76 by the retrieved random number “R” to recover the video stream. In this manner, the key pair used to encrypt the programming can be changed for every TV program, or during such other interval as may be desired. In a present embodiment, multiplication is used instead of the fill public key cryptography encryption/decryption technique because it requires less computation time, but it is contemplated that full public key cryptography encryption and decryption can be used where desired and/or convenient.

In another embodiment of the invention, referring now to FIG. 10, a system for secure broadcast is indicated generally at 30a. Despite certain important differences, system 30a is similar to system 30, and like components in system 30a to components in system 30 have the same reference character followed by the letter “a”. In contrast to system 30, the set top box 70b of subscriber station 38a in system 30a is simply a conventional Pay-TV set top box, which may or may not have its own smart card. Subscriber station 38a also includes an access control device 98 which handles the secure broadcast features described above in relation to STB 70 of system 30. By the same token, HEO 34a additionally includes a conventional pay-TV encryption device 99, which operates in substantially the same manner as any prior art conventional pay-TV encryption devices for encrypting programming prior to satellite broadcast. HEO 34a thus also includes an encryption device 58b which only handles the novel security features of HEO34a that are used to correspond with and otherwise support the security features found in access control device 98. In general, it should be understood that device 98 and device 99 enable the secure broadcast technique described with reference to system 30 to be retrofitted into an existing broadcast system.

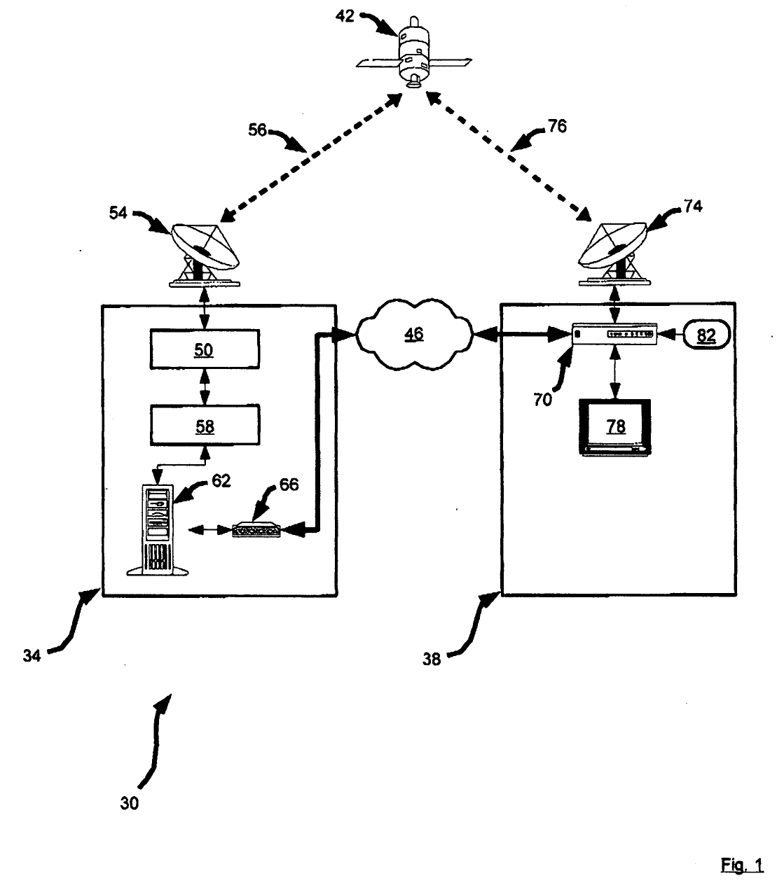

While only specific combinations of the various features and components of the present invention have been discussed herein, it will be apparent to those of skill in the art that desired subsets of the disclosed features and components and/or alternative combinations of these features and components can be utilized, as desired. For example, while the foregoing embodiments have been explained with reference to a secure satellite Pay-TV broadcast system, it should be understood by those skilled in the art that the method and apparatus is in not limited to the configuration shown in FIGS. 1 and 2. For example, the present invention can be also be applied to other broadcasting medium such as cable and internet multicast.

Furthermore, it is to be noted that the use of PSTN 46 in system 30 is merely exemplary, and in other embodiments, other types of communication networks interconnecting HEO 34 and subscriber station 38 can be used, such as the internet. It is to be further noted satellite 42 is also exemplary, and could also be a CATV network. Furthermore, while system 30 refers to subscriber station 38 being operable to receive satellite broadcasts from satellite 42, it is also contemplated that subscriber station 38 can be operable, in certain embodiments, to transmit to satellite 42.

It should now also be apparent that the communications carried over PSTN 46 and via satellite 42 in system 30 could also be carried over a single communication network that had appropriate capacity, network security and so forth. It should also be apparent that in other variations of the invention, PSTN 46 could be omitted where system 30 was being used simply for secure broadcast, and thus this modified system 30 would not be used for updating user profiles UP in smart card 82. By the same token, where it is desired to only have a system used for updating user profiles UP in a smart card 82, then the portions of system 30 dedicated to carrying channels 56 and 76 can be omitted. In the foregoing example, it is thus contemplated that the updated smart card 82 would be removed for insertion into a set-top box of another system that is intended to carry and present channel 76.

Furthermore, while the embodiments have been described herein with regard to television broadcasts, the embodiments herein can be modified to work with other types of broadcasts, such as audio-only radio broadcasts, or data broadcasts (i.e. internet via satellite). Other types of broadcasts to which the embodiments herein can be applied will now occur to those of skill in the art.

The present invention provides a novel system, method and apparatus for secure broadcast. The secure broadcast of the present invention utilizes the encryption/decryption of Pay-TV signal (or the like) using public key cryptography, a matching at the STB between the serial number of the STB and the profile stored on the smart card to authorize decryption of the received signal, and the secure update of user profile and private key in the STB using a PSTN channel or the like.

The above-described embodiments of the invention are intended to be examples of the present invention and alterations and modifications may be effected thereto, by those of skill in the art, without departing from the scope of the invention which is defined solely by the claims appended hereto.

1. A removable security device for communication with one or more subscriber stations that each have a unique identifier, said device comprising a medium for storing a user profile, said user profile including a second identifier for instructing said subscriber station to receive programming if said second identifier corresponds to said unique identifier.

2. The security device according to claim 1 wherein said unique identifier is a serial number of a set top box respective to said subscriber station and said second identifier is a second serial number and said correspondence occurs when said serial numbers match.

3. The security device according to claim 1 wherein said device has a form factor selected from the group consisting of a smart card, a radio-frequency tag, and a magnetic stripe card.

4. The security device of claim 1 wherein said medium is rewritable for updating said user profile.

5. The security device of claim 1 wherein said subscriber station is a pay-TV subscriber station.

6. The security device of claim 1 wherein said user profile is stored in an encrypted format and said subscriber station includes a means for decrypting said user profile.

7. The security device of claim 1 wherein said user profile further includes an encryption key for decrypting programming received at said subscriber station.

8. The security device of claim 1 wherein said user profile further includes subscriber programming information for instructing said subscriber station to decrypt only selected portions of programming received at said subscriber station.

9. A receiver operable to communicate with a removable security device for storing an indicium, said receiver being operable to present data received by said receiver only if said indicium matches a criterion unique to said receiver.

10. The receiver according to claim 9 wherein said receiver is a subscriber station in a pay-tv system and said data is a broadcast.

11. The receiver according to claim 10 wherein said removable security device further includes subscriber programming information and said receiver only present a portion of said broadcast corresponding to said subscriber programming information.

12. The receiver according to claim 9 wherein said receiver has a serial number and wherein said criterion is met only if said indicium matches said serial number.

13. A system for broadcasting comprising:
a transmitter operable to broadcast over a channel; and
a receiver operable to receive said broadcast over said medium, said receiver further operable to communicate with a removable security device that stores an indicium, said receiver only operating to present said received broadcast if said indicium meets a criterion local to said respective subscriber station.

14. The system according to claim 13 wherein said receiver is a subscriber station.

15. The system according to claim 14 wherein said indicium is a serial number of said subscriber station and said criterion is met if said indicium matches said serial number.

16. The system according to claim 13 wherein said transmitter is a head-end office and said broadcast is a Pay-TV service.

17. The system according to claim 16 wherein said channel is at least one wireless channel carried by a satellite.

18. The system according to claim 16 wherein said channel is a CATV network.

19. The system according to claim 13 wherein said broadcast encrypted and said broadcast is presented by decrypting said broadcast.

20. The system according to 19 wherein a decryption key for said broadcast is stored on said removable security device and said decryption key is usable by said receiver to present said broadcast only if said indicium meets said criteria.

21. The system according to claim 16 wherein a selected set of subscriber program information is stored on said removable security device and said receiver only presents a portion of said broadcast corresponding to said selected set.

22. The system according to claim 13 wherein said removable security device stores an additional item and said receiver is operable to request an update to said additional item from said transmitter via said medium, said transmitter fulfilling said request only if said indicium meets said criterion.

23. The system according to claim 22 comprising a second channel and wherein said request is carried over said second channel.

24. The system according to claim 23 wherein said second channel is the public switched telephone network.

25. The system according to claim 22 wherein said additional item is a decryption key for said broadcast and said decryption key is usable by said receiver to present said broadcast only if said indicium meets said criteria.

26. The system according to claim 22 wherein said additional item is a selected set of subscriber program information and wherein said receiver only presents a portion of said broadcast corresponding to said selected set.

27. The system according to claim 13 wherein said indicium is encrypted on said removable security device and said receiver stores a decryption key for reading said encrypted indicium.

28. A removable security device for communication with one or more subscriber stations, said device comprising a medium for storing an indicium respective to one of said subscriber stations such that said respective subscriber will operate to receiving programming only if said indicium meets a criterion local to said respective subscriber station.

29. The device according to claim 28 wherein said criterion is met if said indicium matches a serial number of said subscriber station.

30. A method of receiving a broadcast comprising the steps of:
downloading a user profile from a removable security device that is in communication with a set-top box having a serial number;
presenting said broadcast only if said user profile includes an indicium that matches said serial number.

31. A method of initializing a set top box having a unique serial number comprising the steps of:
initializing said set-top box;
downloading a user profile from a smart card in communication with said set-top box;
determining if said user profile contains an indicium that matches said serial number,
terminating said initialization if said indicium does not match said serial number, and,
completing said initialization if said indicium matches said serial number.

32. The method according to claim 31 comprising the additional steps of:
extracting a decryption key from said user profile for decrypting broadcasts received by said set-top box;
decrypting said broadcast using said decryption key; and,
presenting said decrypted broadcast.

33. The method according to claim 32 comprising the additional step of:
extracting subscriber program information from said user profile;
presenting only a portion of a received broadcast that corresponds with said subscriber program information.

34. The method according to claim 3) wherein said user profile is stored in an encrypted format on said smart card and wherein said set-top box contains a decryption key for decrypting said user profile, said method comprising the additional step of, after said downloading step, decrypting said user profile using said decryption key.

35. A method of updating a user profile stored on a smart card in communication with a set top box comprising the steps of:
transmitting, from said set top box, a request to update said user profile;
transmitting, from said set top box, said user profile to a bead end office;
determining, at said bead end office, whether said user profile contains an indicium that matches a serial number of said set top box;
terminating said method if said indicium does not match said serial number;
generating, at said head end office, an updated user profile based on said request;
transmitting, from said head end office, said updated user profile to said set top box; and,
storing said updated user profile on said smart card.

36. The method according to claim 35 wherein said user profile is transmitted in an encrypted format during at least one of said transmitting steps.

37. The method according to claim 35 wherein said user profile contains a decryption key usable by said receiver to decrypt said broadcast only if said indicium matches said serial number.

38. The method according to claim 35 wherein said user profile contains a selected set of subscriber program information and wherein said receiver is operable to only present a portion of said broadcast corresponding to said selected set.

39. A set top box having a unique serial number comprising:
means for initializing said set-top box;
means downloading a user profile from a smart card in communication with said set-top box;
means for determining if said user profile contains an indicium that matches said serial number;
means for terminating said initialization if said indicium does not match said serial number; and,
means for completing said initialization if said indicium matches said serial number.

40. The set top box of claim 39 further comprising:
means for extracting a decryption key from said user profile for decrypting broadcasts received by said set-top box;
means for decrypting said broadcast using said decryption key; and,
means for presenting said decrypted broadcast.

41. The set top box of claim 39 firth comprising:
means for extracting subscriber program information from said user profile; and
means for presenting only a portion of a received broadcast that corresponds with said subscriber program information.
